(19) United States
(12) Patent Application Publication
(10) Pub. No.: US 2007/0210718 A1
(43) Pub. Date: Sep. 13, 2007

(54) Remote light switching device

(76) Inventor: Luis Taveras, Anaheim, CA (US)

Correspondence Address: MICHAEL A. SHIPPEY, PH. D., 4848 LAKEVIEW AVENUE, SUITE B, YORBA LINDA, CA, 92886, US

(21) Appl. No.: 11/372,381

(22) Filed: Mar. 8, 2006

(51) Int. Cl. H05B 37/02

(52) U.S. Cl. 315/149

(57) ABSTRACT

The invention herein described is a device and method for the remote lighting of a single lamp within a circuit of lights. The device also can be installed to control the entire circuit, as is commonly done with light circuits today. The device of the current invention can be easily installed as an aftermarket device. It is operated by a common household flashlight, or a laser pen, and is not dependent upon a dedicated and programmable remote control unit.

### BACKGROUND OF THE INVENTION

1. Field of the Invention

This invention relates generally to the field of light dimmers and remote light switches. More specifically, this invention relates to aftermarket adapters to achieve remote control of lighting fixtures.

2. Description of the Related Art

Light control has progressed from static wall on/off switches to dimmer switches and remote control of lighting. Remote control of lighting is achieved in the industry with dedicated remote control units. These units typically operate by infrared or radio transmission. The units are small, often fragile, and easily lost or mislaid. Indeed, small remote control units often are sold with a holster, which is wall-mountable, thus converting the remote unit to a static wall switch.

In the arena of lighting control, most systems have the following features:
Static switch control or dedicated remote switch
Switch operates on one entire circuit
Switch utilizes radio control of lighting
   In a circuit of lights, such as ceiling recessed lighting, wall light soffits, or track lights, typically several lights share a single electrical circuit. A dimmer on the system operates all lights at one time. All are dimmed or brightened to the same lighting level.

There is thus a need in the industry for a simple, efficient device and method for the remote control of lighting within a room. There is a further need for control of a single light fixture at a time among a group of lights sharing a single circuit. Finally, there is a need to have a remotely controlled lighting system that is not dependent on a dedicated remote unit that is easily lost or broken.

### SUMMARY OF THE INVENTION

The invention herein described is a device and method for the remote lighting of a single lamp within a circuit of lights. The device also can be installed to control the entire circuit, as is commonly done with light circuits today. The device of the current invention can be easily installed as an aftermarket device. It is operated by a flashlight or laser pen, and is not dependent upon a dedicated remote control unit.

A primary object of the current invention is to provide easy remote control of a single light in a group of lights on a common circuit.

Another object of the invention is to provide remote control of lights with an ordinary flashlight.

Another object of the invention is to remote control of dimming and brightening of lights.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an exploded view of the present invention with stylized components.

FIG. 2 is a view of the present invention as assembled on individual lamps in a track lighting system, with remote control devices depicted.

FIG. 3 depicts a perspective view of the assembly of the present invention on a lamp in a track lighting system, again with remote control and static control devices depicted.

FIG. 4 contains two views of the exterior of the adapter of the present invention, from top and bottom perspective views.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

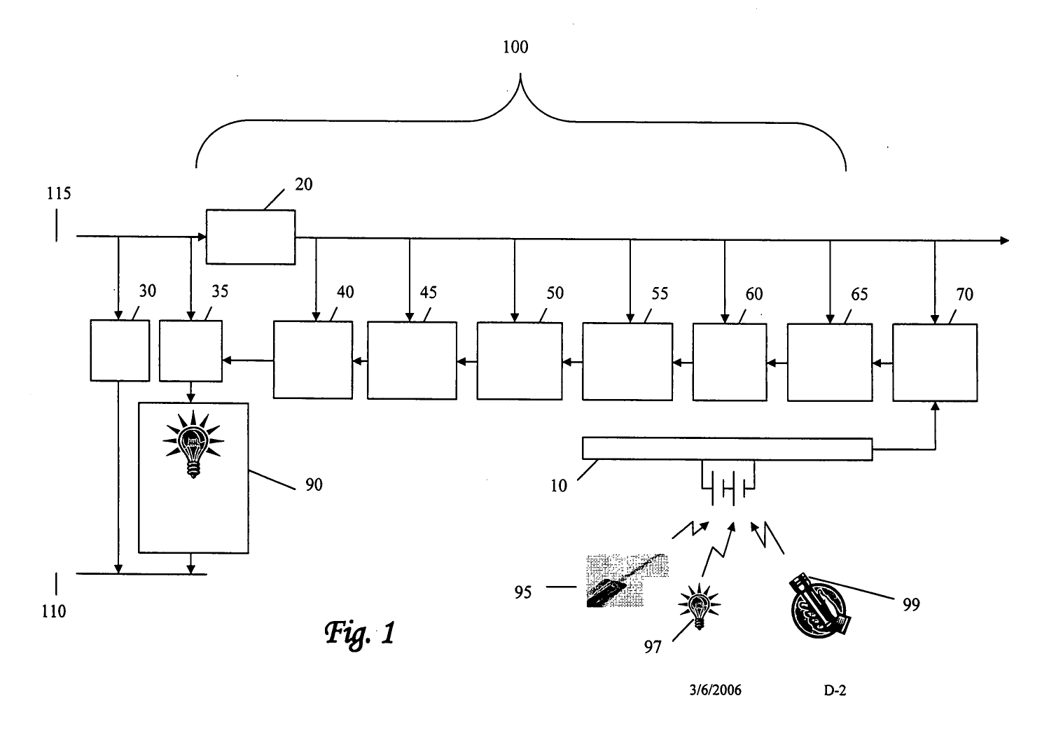

FIG. 1 depicts the components of the invention in a block diagram view. The basic structure of the invention is an assembly of electronic components 100. This circuit comprises a DC circuit linked to an AC circuit. The hot side 115 of the AC circuit is wired to a voltage AC to DC converter 20. Thus, DC components are powered by DC electrical current, while AC components remain powered by AC. Such a dual power circuit is well known in the art.

The components found on the left side of FIG. 1, within the AC-only circuit, are the AC RFI line filter 30 and the AC TRIAC lamp driver 35. These components are designed to dampen and minimize fluctuations in the lighting produced by the lamp 90. Note that the lamp 90 is not part of the current invention. Rather, the invention is used to control the operation of a lamp. The lamp 90 further connects to the neutral side 110 of the AC line, as does the AC RFI line filter 30.

Moving to the right of the figure, against the directional arrows, we come to the next two components, AC phase dimmer control chip 40 and on/off and dimming control memory chip 45. The components are used to control the dimming and recall of lighting level of the lamp controlled by the present invention. There are also initiator components, not shown in FIG. 1, that can be used to initiate the lamp on or lamp off sequence. These can be integrated into 40 and 45.

Again moving to the right, we next come to the single pass generator 50, fed by a signal inverter (not shown). The signal to these units comes from the light level threshold detector/analog to digital converter 55. Converter 55 is the principal component that converts the input control signal, ultimately from the user, into a digital signal that controls the light level of lamp 90.

Converter 55 in turn is supplied the input control signal from the light sensor differentiator component 70 (LSDC). The signal is first amplified by a high gain amplifier 65, and modified by a low pass input filter 60. LSDC 70 is the component that detects the change in light resulting from a pass of a beam of external light on the photo-electronic cell.

Finally, we come to the photo-electronic cell light sensor 10. The sensor 10 is the heart of the present invention. The sensor 10, a type of photoelectric cell, senses changes in ambient light. These changes are produced by shining a light on light sensor 10. The external light can come from a hand-held laser light 95, an external light 97, a flashlight 99, or any external light source that can project light on the face of cell light sensor 10.

Extensive research has demonstrated that the best candidate for use in the photo-electronic cell light sensor of the present invention is an amorphous silicon solar cell. This type of photo-electronic cell provides several advantages in the present invention over a standard photoelectric cell. Perhaps the most important such advantage is that the solar cell offers a much larger lens area as a target for the external light source that is used to activate the lamp control of the current invention. A standard photoelectric cell offers a very tight target area that would prove very difficult for a casual user operating a handheld flashlight or other light source.

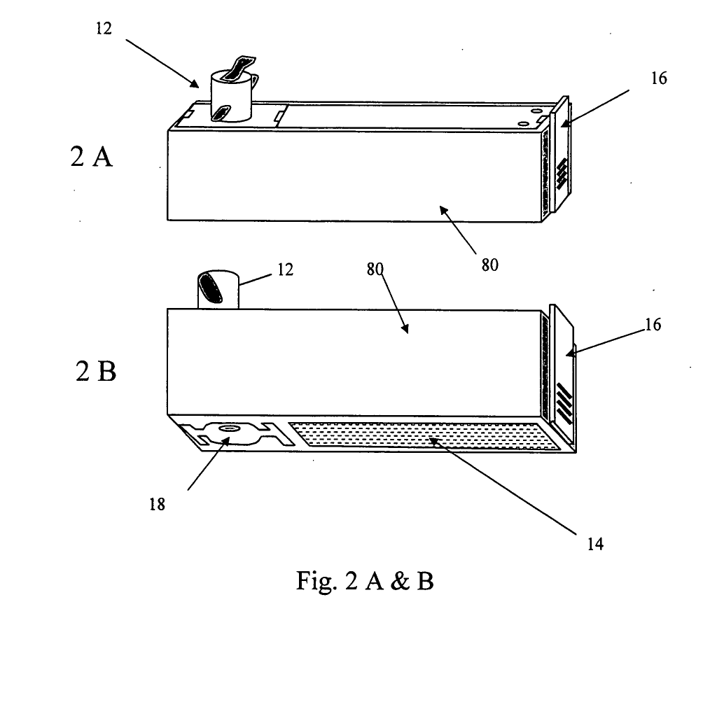

FIG. 2 shows the completed assembly of the present invention from two views. In FIG. 2A, the adapter of the present invention is displayed from an upper perspective view. A rectangular housing 80 contains most of the components displayed in FIG. 1. Latching connector 12 at the top of housing 80 is designed to latch onto the track of track lighting, and receive AC power from the track. Thus connector 12 acts as both a support and a power connector for the current invention. Also present in this view is the sliding tab 16, which allows secure latching of housing 80 onto the track of a track lighting system.

FIG. 2B shows the completed adapter assembly of the present invention from a lower perspective view. The rectangular housing 80 and latching connector 12 at the top of housing 80 are both visible. Socket 18 at the lower part of housing 80 is the connection port for a lamp, as in a track lighting system. Also present in this view is the transparent lens 14, which admits light into the photoelectric cell 10 within housing 80.

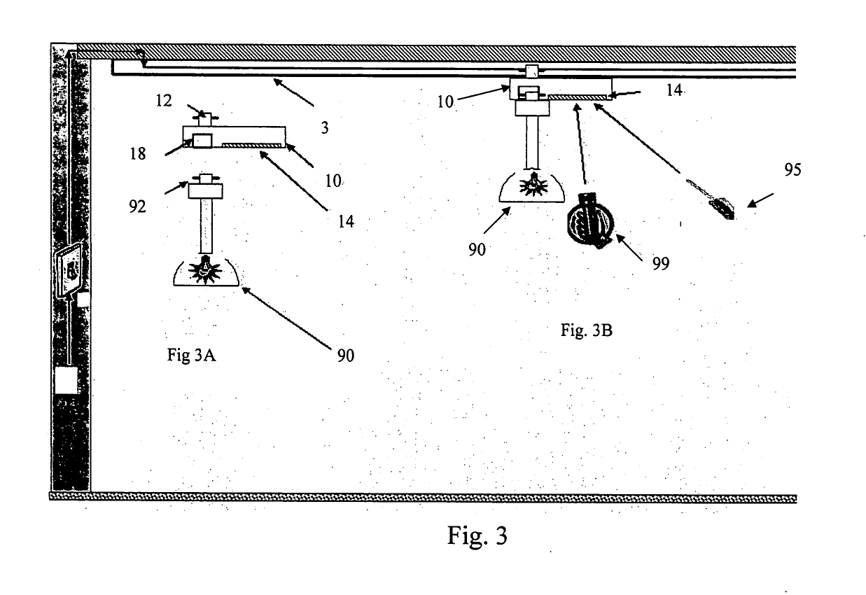

FIG. 3 shows the assembly of the present adapter 100 into a complete electrical track 3 of a track lighting system. The parts to be assembled are seen in FIG. 3A. Lamp 90, adapted with a track connector 92, will mate with the socket 18 on the bottom side of housing 80. The upper latching connector 12 is then connected onto electrical track 3. Once this is latched in place, the system is operational, as shown in FIG. 3B.

In FIG. 3B, the assembled collection of lamp 90 and adapter 100 is shown in position on electrical track 3. External lamp 90, the laser pen 95, and the flashlight 99 can be utilized to control the lamp 90 attached to adapter 100.

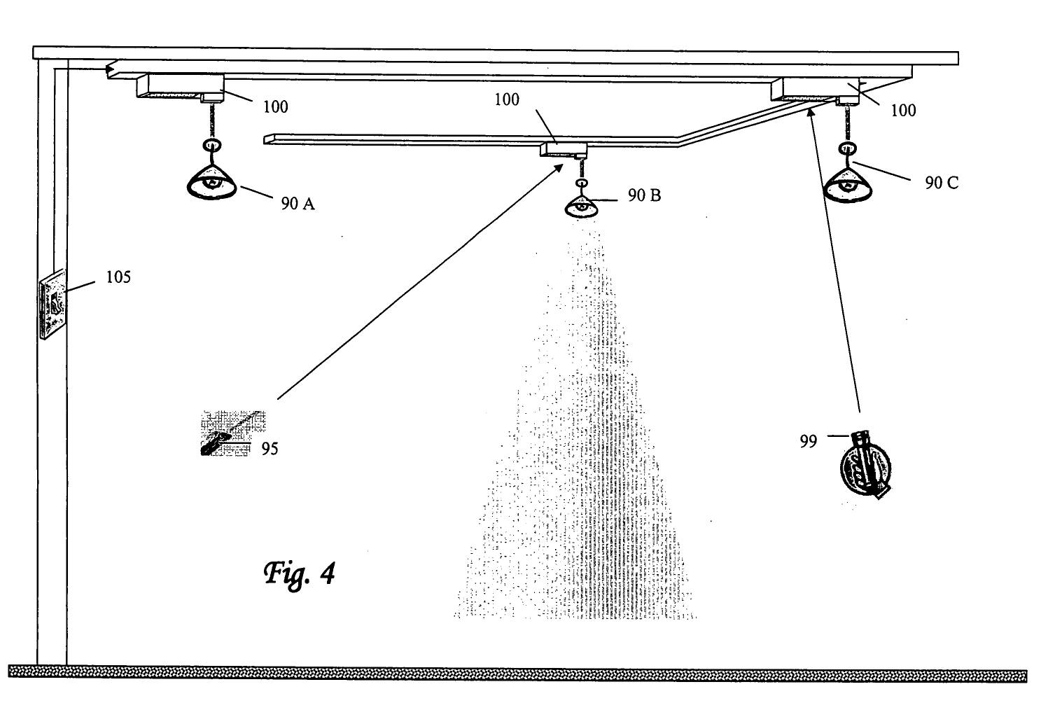

In FIG. 4, three different lamps, 90a, 90b, and 90c are displayed as part of a single track lighting system. Each lamp is controlled by an adapter 100 of the current invention. Lamp 90a is in the off position. Lamp 90c also is off, but is being turned on by operation of a flashlight 99. In the center of the figure, lamp 90b is in the on position, and is being controlled—either turned off, or dimmed—by a laser pen 95. Thus, it is seen that individual lights on a single system can be controlled with the current invention. Existing control switches for a track lighting system, such as the wall switch 105 depicted in the figure, will control the entire track. All lamps can be turned on and off, or dimmed, at one time and to the same extent. The current invention can control a single lamp out of a system of many.

The chips must be engineered to convert the signal from the external light into the appropriate control for the lamp to be remotely controlled. Several such sequences are possible. We have developed a simple sequence that only requires two distinct signals from the external light: a single pass of the external light beam across the face of the lens of the adapter, and a series of two such passes in quick succession.

The user simply chooses the lamp he wishes to operate, and ensures that the track has power. Then he or she passes the beam of the flashlight in a quick succession of two passes of the flashlight beam across the adapter lens. This will turn the lamp on, if previously off. Another double pass of the flashlight beam will turn the flashlight off.

When the lamp is on, a single pass of the flashlight beam across the adapter lens will start the dimmer in action. The lamp will be dimmed until it reaches its lowest position, or until interrupted. Another single pass of the flashlight beam will interrupt the dimming, so the light remains at the dimmed output last reached. The next single pass of the flashlight beam will start the dimmer in reverse (brightening) mode.

Also, a single pass of the flashlight beam across the adapter lens will both turn the lamp on, and set the dimming feature in action.

The advantages of this system are thus apparent. The user does not need a dedicated remote control unit, but instead can use a flashlight or other portable light sources to act as a remote control. These are commonly available in homes, and are easily obtainable at stores. The user is not likely to be hunting for a lost remote, or replacing a broken unit.

Also, the user can retro-fit her existing track lighting system with adapters of the modern invention. The track can be adapted at all lamps, or only at one or a few positions. For instance, a lamp over a reading chair can be controlled to a bright light for reading purposes, while other lamps on the system are kept dim.

Although the invention is described above as a portable device for controlling one lamp, it can be easily converted to a switch for an entire circuit. The lens can be wall-mounted, and a flashlight or other portable light can be used to control the light from the entire circuit.

Note that the critical feature of the present invention is control of a lamp by means of rapid changes in ambient lighting sensed by the photo-electronic cell. Control is normally accomplished by the preferred, positive means described above, using an external flashlight or other light source. In fact, the present invention works equally well by rapid light deprivation means. Thus, the user can operate the adapter in a well lighted room by passing a shadow across the adapter lens, once or twice in quick succession. The shadow can be created by any solid object capable of being passed across the face of the lens. A broom, for instance, works well in this process.

Of course, lamp control in the presence of ample ambient light is not a normal goal. Thus, the flashlight means of control, which works in a totally darkened room as well as a lighted room, is much the preferred mode of operation.

It should be noted that the present invention operates with any standard 110/120 Volt lamp or lighting system. It can also be readily adapted to a lower voltage system, such as often found in halogen lighting systems. This just requires a stepdown voltage converter in the adapter system. Such converters are well known in the art.

While the invention has been described in connection with a preferred embodiment or embodiments, it is not intended to limit the scope of the invention to the particular forms set forth; but on the contrary, it is intended to cover such alternatives, modifications, and equivalents as may be included within the spirit and scope of the invention as defined by the appended claims.

I claim:

1. A device for operating a remote light fixture, comprising:
A photo-electronic switch;
A connector for a light bulb to connect to said device;
Connection means to a standard AC wall circuit; and,
A housing with lens to admit light to said photo-electronic switch.

2. The device of claim 1, wherein said photo-electronic switch is capable of turning the electrical power to said light bulb on and off.

3. The device of claim 1, wherein said photo-electronic switch is operable by sensing a light from a remote lighting unit.

4. The device of claim 1, further comprising dimming means for said light bulb.

5. The device of claim 1, wherein said switch is capable of dimming said light bulb by sensing a light from a remote lighting unit.

6. The device of claim 1, wherein said photo-electronic switch is engineered to alternatively open and close the electronic circuit when it senses a passing beam of light from a flashlight.

7. The device of claim 1, wherein said photo-electronic switch is engineered to begin varying the power to the electronic circuit when it senses a passing beam of light from a flashlight.

8. The device of claim 1, further comprising a light level threshold detector/analog to digital converter.

9. The device of claim 1, further comprising a light sensor differentiator.

10. The device of claim 1, wherein said light bulb is an element of a track lighting system.

11. The device of claim 1, wherein said photo-electronic switch is mounted to the track of a track lighting system.

12. The device of claim 1, wherein said device is capable of operating a lamp that accepts 110 volts.

13. The device of claim 1, wherein said device is capable of operating a lamp that accepts 12-24 volts.

14. A device for operating a remote light fixture, comprising:
A photo-electronic switch, capable of controlling the current output to on, off, and continuously varying modes;
A socket receptacle and connector for a light bulb;
A light level threshold detector/analog to digital converter;
A light sensor differentiator;
Connection means to a standard AC wall circuit; and,
A housing with lens to admit light.

15. A method for the remote operation of a light fixture, using the device of claim 1, said method comprising the steps of:
Installing the device of claim I on the light fixture;
Aiming a flashlight at the lens of the device;
Passing a light beam across the lens of the device once to start dimming, or to stop dimming; and,
Passing a light beam across the lens of the device twice in rapid succession to turn the light on, or off.
